(19) United States
(12) Patent Application Publication
(10) Pub. No.: US 2024/0016153 A1
(43) Pub. Date: Jan. 18, 2024

(54) WHEAT SEED PRODUCTION

(71) Applicant: PIONEER HI-BRED INTERNATIONAL, INC., JOHNSTON, IA (US)

(72) Inventors: MARC C. ALBERTSEN, GRIMES, IA (US); JESSIE LYNN ALT, MADRID, IA (US); BILL S. CURRAN, EVANS, CO (US); MARK E. WILLIAMS, JOHNSTON, IA (US)

(73) Assignee: PIONEER HI-BRED INTERNATIONAL, INC., JOHNSTON, IA (US)

(21) Appl. No.: 18/351,638

(22) Filed: Jul. 13, 2023

Related U.S. Application Data
(60) Provisional application No. 63/368,578, filed on Jul. 15, 2022.

(51) Int. Cl. A01N 45/00; A01N 37/38; A01P 13/00; A01N 53/00; A01N 59/08

(52) U.S. Cl. CPC A01N 45/00; A01N 37/38; A01P 13/00; A01N 53/00; A01N 59/08

(57) ABSTRACT

Methods are provided to increase hybrid seed yield in wheat seed production. Methods for enhancing pollination success and limiting the proportion of self-fertilized male seed in the final produced seed stock are provided.

### CROSS REFERENCE TO RELATED APPLICATIONS

This application claims the benefit of U.S. Provisional Patent Application Ser. No. 63/368,578, which was filed in the U.S. Patent and Trademark Office on Jul. 15, 2022, the entirety of the disclosure of which is expressly incorporated by reference herein.

### FIELD OF THE INVENTION

The present invention relates to the field of plant molecular biology, more particularly to improving wheat hybrid seed production.

### BACKGROUND

Development of hybrid plant breeding has made possible considerable advances in quality and quantity of crops produced. Increased yield and combination of desirable characteristics, such as resistance to disease and insects, heat and drought tolerance, along with variations in plant composition are all possible because of hybridization procedures. These procedures frequently rely heavily on providing for a male parent contributing pollen to a female parent to produce the resulting hybrid.

Field crops are bred through techniques that take advantage of the plant's method of pollination. A plant is self-pollinating if pollen from one flower is transferred to the same or another flower of the same plant or a genetically identical plant. A plant is cross-pollinated if the pollen comes from a flower on a different plant.

In certain species, such as Brassica campestris, the plant is normally self-sterile and can only be cross-pollinated. In self-pollinating species, such as soybeans, cotton and wheat, the male and female plants are anatomically juxtaposed. During natural pollination, the male reproductive organs of a given flower pollinate the female reproductive organs of the same flower. Maize has male flowers, located on the tassel, and female flowers, located on the ear, on the same plant and can be bred by both self-pollination and cross-pollination techniques.

Successful pollination of the female from the male of the hybrid cross is critical to economical seed production. Traditionally, hybrid seed production involves planting out separate rows or blocks of female and male parent lines with only the seed from the female parents being harvested. To ensure that this seed is hybrid, self-pollination of the female parent line must be minimized by rendering the line male sterile. Methods for making the female parent line male sterile include mechanical, chemical and genetic methods. In monoecious plants, such as maize, male sterility can be readily achieved mechanically by detasselling of the male inflorescence. In contrast, wheat flowers are perfect flowers and contain both male and female parts in one flower, making mechanical methods for male sterility impractical.

Hybrid wheat can be obtained through the use of a chemical hybridization agent (CHA). Male and female plants are planted in strips and a CHA is used to prevent pollen formation in female plants. The most commonly used CHA for commercial hybrid wheat production is Croisor® 100 from Saaten-Union.

The same strip or row seeding production system can be used with male sterile female plants obtained from the use of genetic traits, such as nuclear male sterility or cytoplasmic male sterility combined with the use of one or more restoratives to obtain fertile hybrid seeds. In wheat, cytoplasmatic male sterility (CMS) could be used, but full restoration of fertility in hybrids is only achieved using several restorer genes, which makes efficient implementation of this method in wheat complex (Würschum et al. 2017. A modern Green Revolution gene for reduced height in wheat. The Plant Journal, 92(5), pp. 892-903).

In addition, these types of traditional hybrid seed production systems involve the use of strip or row planting of male and female plants, which creates a physical distance between the separate rows or blocks of the male and female parent lines. Here cross-pollination ability is a problem in crop species, such as wheat, where pollen dispersal is limited compared to other cross-pollinated crop species (De Vries, 1971. Flowering biology of wheat, particularly in view of hybrid seed production—a review. Euphytica, 20(2), pp. 152-170; Waines and Hegde, 2003. Intraspecific gene flow in bread wheat as affected by reproductive biology and pollination ecology of wheat flowers. Crop Science, 43(2), pp. 451-463). In crops such as wheat, a large portion of the hybrid-producing field must be planted with male pollen-donor plants to make hybrid seed production economical.

A need exists for a more economical and efficient hybrid wheat seed production system. The current application relates to improvements in methods for the production of wheat hybrid seed.

### SUMMARY OF INVENTION

One aspect of the present invention is a method of increasing wheat hybrid seed production in a field comprising the steps of (a) planting male and female parent wheat plants in a field; (b) treating the male parent plants with a topical treatment; and (c) quantifying hybrid seed production; wherein hybrid seed production is increased with respect to a control planting. In one aspect, the topical treatment is a spray. In a further aspect, the topical treatment is selected from the group of a gibberellin, a plant growth regulator with trinexapac-ethyl as the active ingredient, a sodium chlorate desiccant, and a phenoxy herbicide with MCPA (2-methyl-4-chlorophenoxyacetic acid) as the active ingredient.

In one aspect, the male parent plants are treated with a gibberellin when they are at Feekes stage 6 or later. In another aspect, the male parent plants are treated with gibberellin when they are at Feekes stage 6 to 8. In one aspect of the invention, the gibberellin is GA3. In another aspect of the invention, GA3 is sprayed at a dose of 2-3 oz of active ingredient (ai)/acre of field area planted.

In one aspect, the male parent plants comprise at least one gibberellin sensitive dwarfing Rht allele. In a further aspect, the male parent plants comprise the Rht24 gibberellin sensitive dwarfing allele. In another aspect, the female parent plants comprise at least one gibberellin insensitive dwarfing Rht allele. In a further aspect, the female parent plants comprise the gibberellin insensitive dwarfing alleles Rht1, Rht2, or a combination of Rht1 and Rht2. In yet a further aspect, the female parent plants further comprise the Rht24 gibberellin sensitive dwarfing allele, in combination with the at least one gibberellin insensitive Rht dwarfing allele.

In another aspect, the male and female parents are interplanted in a field. In a further aspect, the male and female parents are planted in a field at an altered seeding rate. In one embodiment, the ratio of field area planted with male parent plants to the field area planted with female parent plants is reduced with respect to the control planting.

In an aspect, treating the male parent plants with a topical treatment results in the male parent plant height at least 3 inches greater than the female parent plant height; a delay in male flowering by at least 1 day; a delay in pollen shed by at least 1 day; a shortened male flowering window of at least 1 day; decreased tillering; or combinations thereof.

In another aspect of the present invention, a method of decreasing contamination of inbred male seed in the wheat hybrid seed production harvest comprises the steps of (a) planting male and female parent wheat plants in a field; (b) treating the male parent plants with a topical treatment; and (c) quantifying hybrid seed production; wherein inbred male seed contamination is decreased with respect to a control planting, wherein the topical treatment is a spray, and wherein the topical treatment is selected from the group of a gibberellin, a plant growth regulator with trinexapac-ethyl as the active ingredient, a sodium chlorate desiccant, and a phenoxy herbicide with MCPA (2-methyl-4-chlorophenoxyacetic acid) as the active ingredient.

In one aspect, the male parent plants are treated with a gibberellin when they are at Feekes stage 6 or later. In another aspect, the male parent plants are treated with gibberellin when they are at Feekes stage 6 to 8. In one aspect of the invention, the gibberellin is GA3. In another aspect of the invention, GA3 is sprayed at a dose of 2-3 oz of active ingredient (ai)/acre of field area planted.

In one aspect, the male parent plants comprise at least one gibberellin sensitive dwarfing Rht allele. In a further aspect, the male parent plants comprise the Rht24 gibberellin sensitive dwarfing allele. In another aspect, the female parent plants comprise at least one gibberellin insensitive dwarfing Rht allele. In a further aspect, the female parent plants comprise the gibberellin insensitive dwarfing alleles Rht1, Rht2, or a combination of Rht1 and Rht2. In yet a further aspect, the female parent plants further comprise the Rht24 gibberellin sensitive dwarfing allele, in combination with the at least one gibberellin insensitive Rht dwarfing allele.

In another aspect, the male and female parents are interplanted in a field. In a further aspect, the male and female parents are planted in a field at an altered seeding rate. In one aspect, the ratio of field area planted with male parent plants to the field area planted with female parent plants is reduced with respect to the control planting.

In an aspect, treating the male parent plants with a topical treatment results in the male parent plant height at least 3 inches greater than the female parent plant height; a delay in male flowering by at least 1 day; a delay in pollen shed by at least 1 day; a shortened male flowering window of at least 1 day; decreased tillering; or combinations thereof.

### BRIEF DESCRIPTION OF THE DRAWINGS AND THE SEQUENCE LISTING

The disclosure can be more fully understood from the following detailed description and the accompanying drawings, which form a part of this application.

FIG. 1 depicts mean inbred grain yield versus plant height of male GA sensitive genotypes treated with GA3.

FIGS. 2A and 2B depict the bivariate analysis of plant height by GA3 treatment across Rht genotypes.

FIGS. 3A and 3B depict mean inbred grain yield versus Rht genotype of male GA sensitive genotypes treated with GA3.

FIG. 4 depicts the effects on mean inbred grain yield of males treated with a chemical desiccant.

### DETAILED DESCRIPTION

The present inventions now will be described more fully hereinafter; some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

All references referred to are incorporated herein by reference.

### I. Definitions

Terms used in the claims and specification are defined as set forth below unless otherwise specified. It must be noted that, as used in the specification and the appended claims, the singular forms “a,” “an” and “the” include plural referents unless the context clearly dictates otherwise.

An “allele” is one of several alternative forms of a gene occupying a given locus on a chromosome. When all the alleles present at a given locus on a chromosome are the same, that plant is “homozygous” at that locus. If the alleles present at a given locus on a chromosome differ, that plant is “heterozygous” at that locus.

The term “crossed” or “cross” or “crossing” in the context of this disclosure means the fusion of gametes via pollination to produce progeny (i.e., cells, seeds, or plants). The term encompasses both sexual crosses (the pollination of one plant by another) and selfing (self-pollination, i.e., when the pollen and ovule (or microspores and megaspores) are from the same plant or genetically identical plants).

The Feekes scale is a numerical scale to identify the growth and development of cereal crops. It begins at Feekes 1.0 (which describes emergence) and ends in 11.4 (which describes a mature plant that is ready for harvest). Additionally, the Feekes scale uses decimal subdivisions to describe development stages during head emergence to maturity (Feekes 10.0 through 11.4). Feekes 1: Emergence, Feekes 2-5: Tillering, Feekes 6-10: Stem Extension, Feekes 10.1-10.5: Heading, Feekes 10.51-10.54: Flowering, and Feekes 11.1-11.4: Ripening. In Large, 1954. “Growth stages in cereals illustration of the Feekes scale”. Plant Pathology. 3 (4): 128-129.

The term “flowering date” refers to the number of days after January 1st when anther extrusion in an observation plot started.

As used herein, “gene” includes a nucleic acid fragment or sequence that expresses a functional molecule such as, but not limited to, a specific protein coding sequence and regulatory elements, such as those preceding (5′ non-coding sequences) and following (3′ non-coding sequences) the coding sequence.

The term “genotype” refers to the physical components, i.e., the actual nucleic acid sequence at one or more loci in an individual plant.

Gibberellins (GA) are a class of diterpenoid plant hormones (see, e.g., Krishnamoorthy (1975) Gibberellins and Plant Growth, John Wiley & Sons). Examples of gibberellins useful in the practice of the present methods include, but are not limited to, gibberellin A1 (GA1), gibberellin A3 (GA3), gibberellin A4 (GA4), gibberellin A7 (GA7), or a combination of two or more thereof. For example, GA4/7 (also referred to as Gibberellin 4/7) indicates a mixture of GA4 and GA7.

As used herein, the term “GA sensitive” wheat plants refer to wheat plants that are responsive to GA treatment. In some aspects, “GA sensitive” wheat plants treated with GA results in increased plant height of those plants. In some examples, treatment with GA results in at least a three-inch increase in plant height. As used herein, the term “GA insensitive” wheat plants refer to wheat plants that are not responsive to GA treatment.

The term “treatment” or “treating” refers to subjecting the male or female or both parent plants to a gibberellin. Examples of ways in which the parent plants can be treated include, but are not limited to, spraying, drenching, swab application, injecting, dusting, and slurry application. A control planting is defined herein as a planting for producing hybrid wheat seeds, where there is no gibberellin application on the parent plants.

As used herein the term “active ingredient” refers to the biologically active component of a commercially available gibberellin formulation.

The term “head” or “spike” refers to the group of spikelets at the top of one plant stem.

The term “heading” refers to the formation of the spike.

The term “heading date” refers to the number of days after January 1st when 75% of the spikes of an observation plot have emerged to 75% from the flag leaf sheath.

With “genetic male sterility (GMS)”, nuclear male sterility (Ms) genes control the male sterility condition without influence of cytoplasmic sequences. In the simplest genetic model, there are three possible genotypes for the nuclear locus Ms, in which the male sterile phenotype is conditioned by recessive ms alleles. A Mendelian inheritance pattern can be observed, in which the offspring of a male sterile genotype (female line) could be entirely male fertile or segregate 50% male sterile: 50% male fertile depending on whether the parental line (male fertile) is homozygous or heterozygous, respectively. The use of GMS in plant breeding and hybrid seed production involves three different lines: i) a male sterile (female parent), ii) a maintainer, and iii) a restorer (male parent) line. The male sterile line is maintained using pollen of a maintainer line, which presents identical genotype (isoline), except for the presence of a dominant Ms allele. However, the perpetuation of the male sterile (female parent) presents a difficulty: the segregation obtained in the cross with the maintainer line implicates an additional step of selecting the male sterile phenotype (identification and removal of heterozygotes) for hybrid seed production. The inefficiency in maintaining the male sterile line had initially restricted the use of GMS in hybrid seed production of crop species in which cytoplasmic male sterility (CMS) had not been found or engineered, as is the case with wheat.

In a “cytoplasmic male sterile (CMS) system”, the male sterile (A-line) is crossed to a sister maintainer line (B-line), which has the identical nuclear genotype but a fertile cytoplasm derived from an elite adapted line. The maintainer line carries recessive restorer allele (rf); therefore, when this male fertile line is crossed to a sterile CMS plant, it creates sterile progeny. For commercial hybrid seed production, a male sterile line must be crossed to a line carrying dominant restorer alleles, or restorer line with excellent pollinator qualities. This is necessary for producing fertile Fi seed. In wheat, two or three major restorer loci are required for complete fertility restoration (Bahl and Maan, 1973. Chromosomal Location of Male Fertility Restoring Genes in Six Lines of Common Wheat 1. Crop Science, 13(3), pp. 317-320). “Interplanting” as used herein refers to a method of planting seeds or plants in a field that ensures adequate cross-pollination of male sterile or conditionally male-sterile plants by the male-fertile plants. This can be achieved either by random mixing of female and male parent seed in different blends (e.g., 80/20 or 90/10) before planting or by planting in specific field patterns whereby different seeds are alternated. When separate harvesting from different plants is required planting in alternating blocks or rows is preferred.

A “molecular marker” refers to a marker or probe (or data derived therefrom) that may be used to identify individuals comprising a locus of interest (e.g. a Reduced height (Rht) dwarfing locus). Thus, a molecular marker linked to Rht dwarfing genes may be used to identify a wheat plant comprising one of the Rht dwarfing loci disclosed herein. Data corresponding to a molecular marker (or data derived from the use of such a marker) may be stored in an electronic medium. Each marker can be used to effectively identify individuals comprising the loci of interest disclosed herein, i.e., one of the Rht dwarfing loci disclosed herein.

“Nick” or “pollination synchronization” is the alignment of flower timing between two parents in a cross or seed production scenario. For successful pollination, female receptivity and pollen shed should occur at the same time.

As used herein, “phenotype” means the detectable characteristics (e.g. dwarfism) of a cell or organism which can be influenced by genotype.

The term “plant” refers to whole plants, plant organs, plant tissues, seeds, plant cells, seeds and progeny of the same. Plant cells include, without limitation, cells from seeds, suspension cultures, embryos, meristematic regions, callus tissue, leaves, roots, shoots, gametophytes, sporophytes, pollen and microspores. Plant parts include differentiated and undifferentiated tissues including, but not limited to roots, stems, shoots, leaves, pollen, seeds, tumor tissue and various forms of cells and culture (e.g., single cells, protoplasts, embryos, and callus tissue). The plant tissue may be in plant or in a plant organ, tissue or cell culture. The term “plant organ” refers to plant tissue or a group of tissues that constitute a morphologically and functionally distinct part of a plant.

The term “plant height” refers to the average height in inches or centimeters of a group of plants, as measured from the ground to the tip of the head, excluding awns.

“Progeny” comprises any subsequent generation of a plant.

The term “Rht function” indicates ability to influence the phenotype of a plant like the Rht gene of wheat. “Rht function” may be observed phenotypically in a plant as inhibition, suppression, repression or reduction of plant growth which inhibition, suppression, repression or reduction is corrected by GA. Rht expression tends to confer a dwarf phenotype on a plant which is corrected by GA. Overexpression in a plant from a nucleotide sequence encoding a polypeptide with Rht function may be used to confer a dwarf phenotype on a plant which is correctable by treatment with GA.

The term “seed rate” refers to the number or quantity of seeds planted per unit of area (e.g., acre or hectare) to ensure optimum population for maximum yield.

As used herein, the term “wheat” refers to any species of the genus Triticum, including progenitors thereof, as well as progeny thereof produced by crosses with other species. Wheat includes “hexaploid wheat” which has genome organization of AABBDD, comprised of 42 chromosomes, and “tetraploid wheat” which has genome organization of AABB, comprised of 28 chromosomes. Hexaploid wheat includes T. aestivum, T. spelta, T. mocha, T. compactum, T. sphaerococcum, T vavilovii, and interspecies cross thereof. Tetraploid wheat includes T. durum (also referred to as durum wheat or Triticum turgidum ssp. durum), T. dicoccoides, T dicoccum, T. polonicum, and interspecies cross thereof. In addition, the term “wheat” includes possible progenitors of hexaploid or tetraploid Triticum sp. such as T. uartu, T. monococcum or T. boeoticum for the A genome, Aegilops speltoides for the B genome, and T. tauschii (also known as Aegilops squarrosa or Aegilops tauschii) for the D genome. A wheat cultivar for use in the present disclosure may belong to, but is not limited to, any of the above-listed species. Also encompassed are plants that are produced by conventional techniques using Triticum sp. as a parent in a sexual cross with a non-Triticum species, such as rye (Secale cereale), including but not limited to Triticale. In some aspects, the wheat plant is suitable for commercial production of grain, such as commercial varieties of hexaploid wheat or durum wheat, having suitable agronomic characteristics which are known to those skilled in the art.

The present invention applies to cereals, particularly oats, wheat, barley, rice, buckwheat, triticale, millet or rye. These are the following autoogamous hybrid cereals: oats (Avena sativa comprising Byzantine; Avena nuda; Avena strigosa), barley (Hordeum vulgare), rice (Oryza sativa), wheat (Triticum aestivum), durum wheat (Triticum durum), spelled (Triticum spelta) and triticale (Triticosecale).

### II. Wheat Hybrid Seed Production

Although most commercial wheat production is from pure-line inbred cultivars, hybrid wheat is also grown. Hybrid wheat is produced with the help of cytoplasmic male sterility, genic male sterility, or chemicals. Various combinations of these three male-sterility systems have been used in the production of hybrid wheat. Cytoplasmic male sterility has been difficult to use due to a lack of effective fertility-restoration genes. Genic male sterility has largely failed due to problems with fertility restoration and maintenance of the male sterile parent. The perpetuation of the male sterile parent presents a challenge because the cross with the maintainer line results in a heterozygous population. Therefore, an additional step of selecting the male sterile phenotype and removing the fertile heterozygotes for hybrid seed production. Chemical hybridizing agent treatment is somewhat inefficient, may cause toxicity problems, and a certain amount of self-pollination occurs which results in the harvested hybrid seed containing some seed of the female parent. In general, the seed hybrids which are produced using CHAs tend to be contaminated with seed of the female parent and removal of this contaminant is difficult.

Although hybrid wheat programs have operated for several decades, hybrids account for a minor fraction of the total area sown. Successful development of hybrid wheat products has been achieved using some of these methods. Hybrid wheat has been produced in China, on a small scale, using T. Timopheevii and Ae. Kotschyi based CMS systems (Longin et al. 2012; Tsunewaki 2015). Through the use of CHAs, the area occupied by hybrid wheat in Europe increased to 565,000 ha (1,400,000 acres) in 2018 (Gupta et al., 2019. Hybrid wheat: past, present and future. Theoretical and Applied Genetics, 132, pp. 2463-2483). Breeding hybrid cultivars by the use of male sterile alloplasms has been successful in bread wheat, cotton (Gossypium spp.), indica rice, pearl millet (Pennisetum glaucum), sorghum (Sorghum spp.), sunflower, tobacco, and some other crops.

Multiple methods are provided herein for improvement of wheat hybrid seed production. In some aspects of the invention, methods are related to improving cross pollination success between male plants and female plants by altering the height of the male plants. In further aspects, methods for improving cross pollination success include the use of mutations in a semi-dwarfing gene. In other aspects, methods are related to improving cross pollination success by altering planting practices. In other aspects, methods are related to improving cross pollination success through pollination synchronization and delayed male flowering. In some aspects of the invention, methods for improving cross pollination success include the use of topical treatments. Improvement of wheat hybrid seed production may comprise at least one, two, three, or more methods described herein.

### III. Mutations in the Rht Semi-Dwarfing Gene and Uses Thereof

Recent decades have seen huge increases in wheat grain yields due to the incorporation of Reduced height (Rht) dwarfing loci into breeding programs. The introduction of the Rht loci (originally known as Norin 10 loci, derived from a Japanese variety, Norin 10) into elite bread-wheat breeding lines was one of the most significant contributors to the so-called “Green Revolution” (Gale and Youssefian, 1985. Dwarfing genes in wheat. In: Progress in Plant Breeding, G. E. Russell (ed) Butterworths, London pp 1-35), which succeeded in improving the harvest index of wheat by a substantially reducing plant height.

The Rht dwarfing loci are now widespread in many European and worldwide wheat varieties (Gale and Youssefian, 1985; Knopf et al., 2008. Occurrence of three dwarfing Rht genes in German winter wheat varieties. Cereal Research Communications. 2008 Dec. 1; 36(4):553-60; Würschum et al., 2015. Genetic control of plant height in European winter wheat cultivars. Theoretical and Applied Genetics, 128, pp. 865-874). Rht mutant alleles in wheat confer a semi-dominant dwarf phenotype, which results in an increased resistance to lodging (flattening of plants by wind/rain with consequent loss of yield). The Rht mutants are dwarfed because they contain a genetically dominant, mutant Rht allele which compromises their responses to gibberellin (GA) (Gale et al, 1976. The chromosomal location of Gai 1 and Rht 1, genes for gibberellin insensitivity and semi-dwarfism, in a derivative of Norin 10 wheat. Heredity, 37(2), pp. 283-289). Thus, the coleoptiles of Rht mutants, unlike those of wildtype wheat plants, do not respond to GA applications.

The Rht mutant alleles of wheat are classified according to their sensitivity to externally applied GA. The GA insensitive alleles conferring the dwarf phenotype include Rht-Bib and Rht-D1b, which were previously known as Rht1 and Rht2 (Guedira et al. 2010. Crop Sci. 50:1811-1822). Seedlings with the GA insensitive dwarfing loci, Rht1 and Rht2 fail to elongate after GA treatment. The GA sensitive alleles conferring a wildtype phenotype include Rht24 (Würschum et al. 2015, 2017; Tian et al., 2017. Molecular mapping of reduced plant height gene Rht24 in bread wheat. Frontiers in plant science, 8, p. 1379). Seedlings with the GA sensitive dwarfing loci, Rht24 will elongate after GA treatment. Most semi-dwarf wheat varieties in the U.S. carry either the GA insensitive Rht1 or Rht2 alleles (Horgan et al., 2021. Seedling elongation responses to gibberellin seed treatments in wheat. Agrosystems, Geosciences & Environment, 4(1), p.e20144).

Although the incorporation of the Rht dwarfing loci has been advantageous in increasing wheat yield, their widespread presence in wheat germplasm poses a problem for hybrid wheat breeding. Optimized pollen diffusion occurs from taller male plants to a shorter set of female plants (Boeven et al., 2016. Genetic architecture of male floral traits required for hybrid wheat breeding. Theoretical and Applied Genetics, 129, pp. 2343-2357). Establishing a wheat hybrid seed production program where GA sensitive Rht dwarfing alleles have been introgressed into the male parents is a challenging task.

Methods described herein are used to improve wheat hybrid seed production. In an aspect of the present invention, a method of increasing wheat hybrid seed production in a field comprises the steps of (a) planting male and female parent wheat plants in a field; (b) treating the male parent plants with a gibberellin; and (c) quantifying hybrid seed production; wherein hybrid seed production is increased with respect to a control planting. In an aspect of the invention, the gibberellin is applied as a topical treatment (e.g. a spray). In another aspect, the gibberellin is GA3 and is sprayed at a dose of 0.5-3 oz of active ingredient (ai)/acre of field area planted. In a further aspect, GA3 is sprayed when the male parent plants are at Feekes stages 6 to 8. In a further aspect, the male parent plant height is at least 3 inches greater than the female parent plant height post-treatment in order to improve successful cross-pollination.

In an aspect, the method of increasing wheat hybrid seed production in a field, further comprises Rht mutant wheat plants. GA sensitive Rht alleles or combinations of alleles are present in the male parent plants of the hybrid wheat seed; and therefore, will elongate after GA treatment of seedlings. In another aspect, the male parent plants comprise the Rht24 GA sensitive dwarfing allele. In an aspect, GA insensitive Rht alleles or combinations of alleles are present in the female parents of the wheat hybrid seed; and therefore, will not elongate after GA treatment of seedlings. In a further aspect, the female parent plants comprise the GA insensitive dwarfing alleles Rht1, Rht2, or a combination of Rht1 and Rht2. In another aspect, the wheat parent plants comprise Rht1, Rht2, Rht24, or combinations thereof.

Wheat plants can be genotyped with molecular markers to determine the presence of GA insensitive or sensitive alleles, for example, Rht1, Rht2, and/or Rht24, or a combination of GA insensitive or sensitive alleles, including but not limited to Rht1 and Rht2, Rht1 and Rht24, Rht2 and Rht24, or Rht1, Rht2, and Rht24.

Rht mutant alleles can be identified and distinguished from wildtype allele using any suitable techniques, including but not limited to allele-specific amplification and PCR-based amplification assays such as TaqMan®, rhAmp-SNP, KASPar, and molecular beacons. Techniques to distinguish between mutant and wildtype Rht alleles can include the use of one or more probes that detect the marker allele in (i) nucleic acid that is isolated from a plant or (ii) an amplicon that is selectively amplified by amplification of nucleic acid isolated from a plant. Optionally, the techniques can further include an additional set of primers and/or one or more probes that detect the presence of a mutant or wildtype Rht allele and thereby determine the zygosity of a mutant or wildtype Rht allele.

Additional methods for genotyping and detecting a Rht mutant for Rht1, Rht2, and Rht24 loci include but are not limited to, hybridization, primer extension, oligonucleotide ligation, nuclease cleavage, minisequencing and coded spheres. Such methods are reviewed in publications including Gut, 2001, Hum. Mutat. 17:475; Shi, 2001, Clin. Chem. 47:164; Kwok, 2000, Pharmacogenomics 1:95; Bhattramakki and Rafalski, “Discovery and application of single nucleotide polymorphism markers in plants”, in PLANT GENOTYPING: THE DNA FINGERPRINTING OF PLANTS (CABI Publishing, Wallingford 2001). A wide range of commercially available technologies utilize these and other methods to detect the desired allele, including Masscode™ (Qiagen, Germantown, MD), Invader® (Hologic, Madison, WI), SnapShot® (Applied Biosystems, Foster City, CA), Tagman® (Applied Biosystems, Foster City, CA) and Infinium Bead Chip™ and GoldenGate™ allele-specific extension PCR-based assay (Illumina, San Diego, CA).

Introduction of Rht mutants for Rht1, Rht2, and/or Rht24 loci may be facilitated using marker-assisted selection (MAS). Using molecular markers, GA sensitive Rht dwarfing alleles may be introgressed into male wheat parents and GA insensitive Rht dwarfing alleles may be introgressed into female wheat parents for use in a production field to produce hybrid wheat seed.

### IV. Interplanting and Uses Thereof

Establishing more efficient pollen transfer is necessary to achieve greater success and more economic hybrid seed production in wheat. A major disadvantage of conventional hybrid seed production systems is the need to plant the male and female parent lines in separate rows, strips or blocks. These sections are separated so that the entire female section can be harvested without contamination with any male inbred seeds. However, this separation of males and females results in inefficient pollination in cereal crop species such as wheat. The small amounts of pollen released are not spread far with the wind and remain viable for only a very short period of time. In such crops, up to two-thirds of a hybrid production field is planted with the pollen donor male plant resulting in an inefficient and costly hybrid seed production process.

In order to achieve more economical seed production in wheat and other cereal crops, it is necessary to move male and female plants close to each other to facilitate more efficient pollen transfer; most effectively, by interplanting the males and females within a few centimeters of each other in the same row. However, it is not practical to harvest only seed from the male sterile female parent in such a system, as the harvested seed contains both the hybrid seed from the fertilized male sterile female and the inbred seed from the self-fertilized male. In addition, there are set standards as to how much contamination of the inbred seed is allowable within the harvested seed (e.g., 95% hybrid seed from the female and 5% inbred seed contamination from the male).

The contamination of harvested seed with inbred seed originating from the male parent can be minimized by using as low a percentage of such male parent plants in the planting mix as possible. However, the low number of male parents planted in combination with the low pollination efficiency described above, may result in a portion of the female plants that will not be pollinated, and therefore, will not produce any grain. This affects the total yield of the seed production field and represents a significant obstacle affecting the efficiency of the interplanting hybrid system. Consequently, most wheat seed production fields are not interplanted with males and females.

One aspect of the present invention is a method of increasing wheat hybrid seed production in a field comprising the steps of (a) interplanting male and female parent wheat plants in a field; and (b) quantifying hybrid seed production; wherein hybrid seed production is increased with respect to a control planting wherein the male and female parents are not interplanted.

### V. Pollination Synchronization and Delayed Male Flowering to Improve Cross-Pollination

Another important part of a successful wheat hybrid seed production system is synchrony between male parent pollen shed and female parent flowering. Pollination synchrony is a general problem with wheat hybrid seed production, particularly with winter wheat, which is planted in the fall. In many crop species that are planted in the spring, synchronization can be achieved by seeding male and female parents on different dates (Yuan, 1985; Virmani, 1994; Rahman et al., 2012). However, for winter wheat, synchronization is not something that can be achieved by changing planting dates in the fall.

There are several components that drive pollination synchrony that may be altered by different methods or combinations of methods to ensure successful pollen delivery from the male to the female. These include altering male flowering timing through the use of topical treatments and altering seeding rates of the male plants. In an aspect of the present invention, a topical treatment is used to slow growth rates in the male parent to delay heading and subsequent flowering. In another aspect of the present invention, a topical treatment is used to limit tillering thereby reducing late emerging spikes in the wheat canopy and shortening the flowering window. In another aspect, the seeding rate of the male plants in a seed production system is reduced to delay male flowering. When male flowering is delayed so that it minimizes overlap with flowering in the female plant, the opportunity for the male plants to self-fertilize is reduced, thereby reducing the production of male inbred seed and contamination of hybrid seed production.

One aspect of the present invention is a method of increasing wheat hybrid seed production in a field comprising the steps of (a) planting male and female parent wheat plants in a field; (b) treating the male plants with a topical treatment to shorten the male flowering window; and (c) quantifying hybrid seed production, wherein hybrid seed production is increased with respect to a control planting. The treatment may be any suitable compound that is able to shorten the male parent wheat plants' male flowering window. The treatment may be delivered in any number of ways, including but not limited to spraying, drenching, swab application, injecting, dusting, and slurry application. In one aspect, the topical treatment is a plant growth regulator with trinexapac-ethyl as the active ingredient or a sodium chlorate desiccant and the topical treatment results in at least 1-day delay in male flowering. In another aspect, the topical treatment is phenoxy herbicide with MCPA (2-methyl-4-chlorophenoxyacetic acid) as the active ingredient and the topical treatment results in a shortened flowering window. In one aspect, the step of treating the male parent plants with a topical treatment is done by spraying the male parent plant with the topical treatment.

Another aspect of the present invention is to delay male flowering enough to decrease the opportunity for self-pollination of males resulting in the production of inbred male seed and contamination of hybrid seed production. An aspect of the present invention is a method to decrease contamination of inbred male seed in the wheat hybrid seed production harvest, comprising the steps of (a) planting male and female parent wheat plants in a field; (b) treating the male plants with a topical treatment to delay male flowering time; and (c) quantifying hybrid seed production, wherein the amount of inbred male seed contamination is reduced in the hybrid seed production harvest with respect to a control planting. The treatment may be any suitable compound that is able to delay the male parent wheat plants' male flowering time. The treatment may be delivered in any number of ways, including but not limited to spraying, drenching, swab application, injecting, dusting, and slurry application. In one aspect, the topical treatment is a plant growth regulator with trinexapac-ethyl as the active ingredient or a sodium chlorate desiccant and the topical treatment results in at least 1-day delay in male flowering. In another aspect, the topical treatment is phenoxy herbicide with MCPA (2-methyl-4-chlorophenoxyacetic acid) as the active ingredient and the topical treatment results in a shortened flowering window. In one aspect, the step of treating the male parent plants with a topical treatment is done by spraying the male parent plant with the topical treatment.

In an aspect of the invention, seeding rates alter male flowering timing. In a further aspect, reducing seeding rate of the male plants in a seed production system can delay male flowering by as much as 2.5 days, which is enough to decrease contamination of seed from self-pollinated males. An aspect of the present invention is a method to decrease contamination of inbred male seed in the wheat hybrid seed production harvest, comprising the steps of (a) planting male and female parent wheat plants in a field, wherein the seeding rate of the male parent plants is reduced; and (b) quantifying hybrid seed production, wherein the amount of inbred male seed contamination is reduced in the hybrid seed production harvest with respect to a control planting.

Combining methods described herein may have increased impact on wheat hybrid seed production and may result in higher yield of hybrid seed or reduced contamination of inbred seed from the male parents. Methods to increase the growth differential between male and female wheat parents to improve cross-pollination success may be used in combination with interplanting the male and female parents in a seed production field. Methods to increase the growth differential between male and female wheat parents to improve cross-pollination success may be combined with methods to delay male flowering. In an aspect of the invention, male parents comprising Rht mutant alleles may be treated with GA3 according to the methods described herein to increase the height of the male parents. The male parents comprising Rht mutant alleles may be further treated with a plant growth regulator with trinexapac-ethyl as the active ingredient or with a sodium chlorate desiccant according to the methods described herein to delay flowering.

In another aspect of the invention, male parent seeds comprising Rht mutant alleles may be planted at reduced seeding rates to delay flowering and resultant seedlings may be treated with GA3 according to the methods described herein to increase the height of the male parents. In another aspect, reduced seeding rates of male parents may be combined with a plant growth regulator with trinexapac-ethyl as the active ingredient or sodium chlorate applications to further delay flowering.

Methods to increase the growth differential between male and female wheat parents to improve cross-pollination success may be combined with methods to shorten the flowering window. In another aspect of the invention, male parents comprising Rht mutant alleles may be treated with GA3 according to the methods described herein to increase the height of the male parents. The male parents comprising Rht mutant alleles may be further treated with a phenoxy herbicide with MCPA (2-methyl-4-chlorophenoxyacetic acid) as the active ingredient according to the methods described herein to shorten the flowering window.

Improvement of wheat hybrid seed production may comprise at least one, two, three, or more methods described herein.

While the invention has been particularly shown and described with reference to a preferred embodiment and various alternate embodiments, it will be understood by persons skilled in the relevant art that various changes in form and details can be made therein without departing from the spirit and scope of the invention. For instance, while the particular examples below may illustrate the methods and embodiments described herein using a specific plant, the principles in these examples may be applied to any plant. Therefore, it will be appreciated that the scope of this invention is encompassed by the embodiments of the invention recited herein and in the specification rather than the specific examples that are exemplified below. All cited patents and publications referred to in this application are herein incorporated by reference in their entirety, for all purposes, to the same extent as if each were individually and specifically incorporated by reference.

### EXAMPLES

The following are examples of specific embodiments of some aspects of the invention. The examples are offered for illustrative purposes only and are not intended to limit the scope of the invention in any way.

Successful pollination (nick) of the female from the male of the hybrid cross is an important consideration in economical seed production. There are several components that drive pollination synchrony that may be altered by different methods or combinations of methods to ensure successful pollen delivery from the male to the female. These include but are not limited to altering plant height, delaying pollen shed from male, altering flowering time, and altering seeding rates to change the pollen shed umbrella.

### Example 1: Effects of GA3 on Plant Height, Pollen Dispersal and Seed Set in GA Responsive and Non-Responsive Wheat Genotypes

A series of field and greenhouse experiments were conducted to understand the effect of GA3 on plant height, pollen dispersal and seed set in GA sensitive and insensitive wheat genotypes. Eight proprietary Hard Red Winter (HRW) wheat varieties or wheat inbred lines were used in this project at two locations. The plants were genotyped for the Rht1, Rht2, and Rht24 mutant alleles to determine which plants were GA3 sensitive or insensitive genotypes.

Commercially available GA3 was applied using a broadcast application to the wheat plants at various vegetative growth stages described by the Feekes Scale. GA3 was applied at different rates of active ingredient (ai)/acre to elucidate the growth response. Experimental treatments were: Untreated, 1 oz ai/acre applied at Feekes stage 6, 1 oz ai/acre applied sequentially at Feekes stage 6 and Feekes stage 8 (2 oz ai/acre total), and 1 oz ai/acre applied sequentially at Feekes stage 6, Feekes stage 8, and Feekes stage 10 (3 oz ai/acre total)

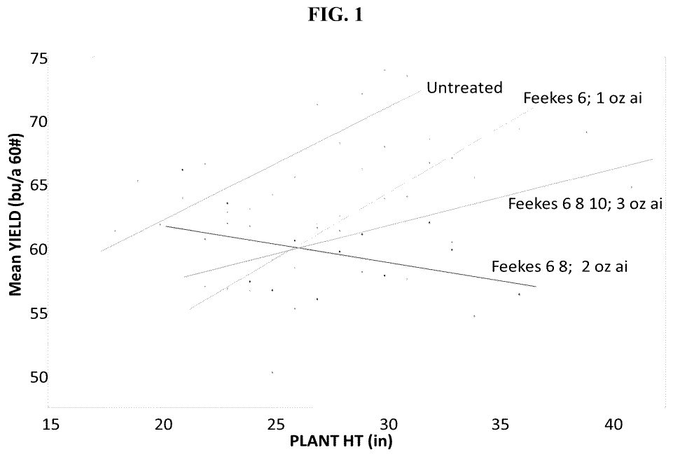

GA3 had a positive effect on wheat plant height on the GA sensitive genotypes when compared to the same GA sensitive genotype that was not treated with GA3. Yield results from the same GA3 treatment and GA sensitive genotype combination resulted in lower wheat yield than the untreated plants. FIG. 1 shows that as plant height increased in male GA sensitive genotypes when treated with GA3, inbred yield from these males decreased.

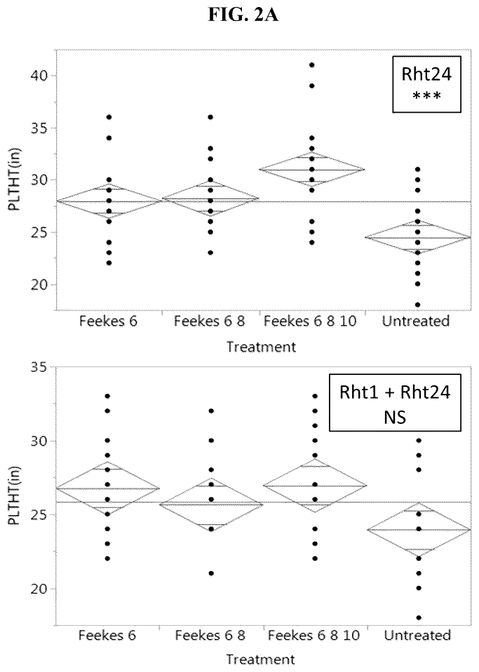

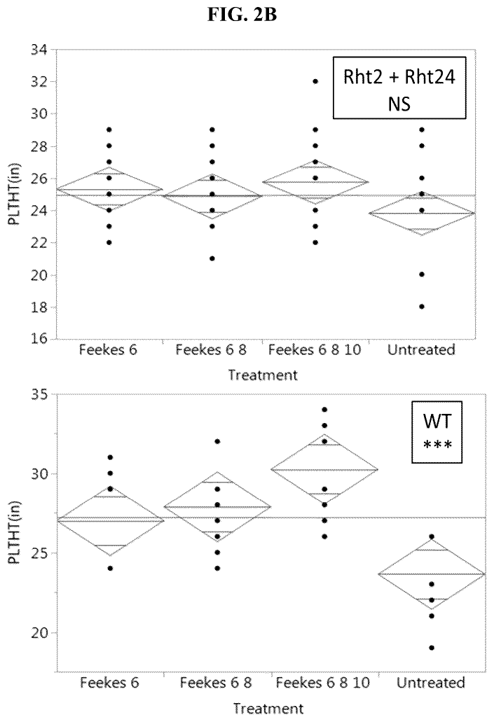

When GA3 was applied during Feekes stage 6 or later (mid- to late vegetative stages of wheat development), the upper internodes elongated, and the plant height was increased significantly (p-value<0.05) from 4 to 7 inches (10.2 to 17.8 cm) in wildtype plants and plants with the Rht24 mutant allele (GA3 sensitive genotypes). Plants with the combination of Rht1 and Rht24 mutant alleles and the combination of Rht2 and Rht24 mutant alleles did not show differences in plant height with GA3 treatments (GA3 insensitive genotype combinations). See FIG. 2. The change in plant height of GA3 sensitive genotypes for optimum cross pollination and seed set met the minimum male plant height difference of 3 inches taller than the female plant height which was determined by a previous internal greenhouse study.

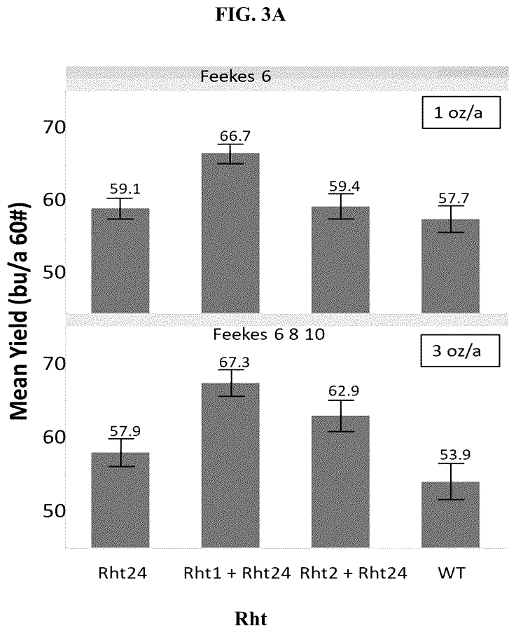

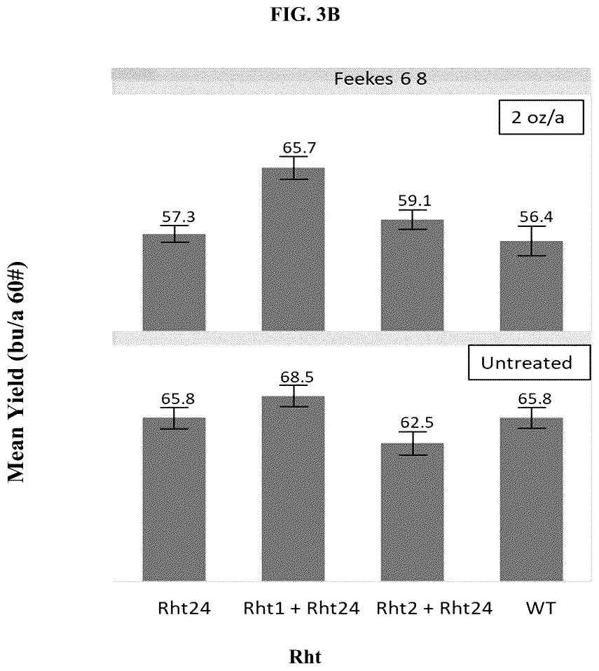

GA3 applications resulted a 0.5 to 1.5-day delay in heading date and flowering date among GA sensitive male genotypes. Heading and flowering did not change in insensitive genotypes. Yield of GA sensitive male genotypes decreased by 11% as a result of the GA3 application. FIG. 3 shows mean yield across inbreds versus Rht genotype, with inbred yield decreasing after treatment with GA3 in GA sensitive Rht genotypes.

This study demonstrated that plant height increased in GA sensitive males with the application of GA3. GA3 can be used to enhance male parent plant height for improved pollen delivery in a large-scale seed production field. In addition, the study demonstrated that inbred grain yield was reduced in GA sensitive males with the application of GA3. These outcomes favor a blended wheat seed production strategy where GA insensitive male sterile females can be blended with GA sensitive males. When seed is produced where the male and female components are blended proportionally at a fixed percentage (95% female and 5% male), there is a clear advantage to having a male produce less yield (inbred seed) and maintaining a higher percentage of yield from females (hybrid seed) in the resulting seed production field. Less dilution from the male blend component results in higher performance gain from the hybrid.

### Example 1.2: Effects of GA3 on GA Insensitive Wheat Genotypes

Field and greenhouse studies were planted to determine if GA3 application has an effect with pollination and male sterile female seed set. GA3 will be applied at various rates (0, 1, 2 and 3 ounces per acres) and times during vegetative growth to male sterile female and male blending studies. The strategy is to use a GA insensitive male sterile female planted with a GA sensitive male in a proportional blending scenario with blend rates of 2.5%, 5%, 7.5%, 10%, or 20% male pollinator. These studies will measure the difference in male sterile female plant height compared to male pollinator plant height, determine seed set, evaluate yield of female genotypes, set standards of hybridity in male-sterile female and male seed production blends using molecular markers. These studies will validate the use of GA insensitive genotypes paired with GA sensitive genotypes for improving hybrid wheat seed production.

### Example 2: Effects of Other Chemical Treatments to Optimize Successful Cross-Pollination

Nick is the alignment of flower timing between two parents in a cross or seed production scenario. To optimize pollination, female receptivity and male pollen shed should occur at the same time. Topical treatments were used to help the biological timing of female receptivity and male pollen shed by altering flower timing, when needed. In addition, topical treatments were used to manage female plant height (shorter A-line) relative to male plant height (taller B-line). A taller male plant relative to the female plant provides an advantage for pollen delivery by the male.

### Example 2.1: Effects of Palisade® EC on Plant Height, Yield, and Flowering in Females

Additional field studies used a commercially available plant growth regulator, Palisade® EC (Syngenta, Greensboro, NC), with trinexapac-ethyl as the active ingredient to reduce plant height in the female in hybrid or A-line and B-line increases. Palisade® EC is widely used as an anti-lodging agent to improve harvestable yield. It was applied using a broadcast sprayer at 2 rates, 10 oz/acre and 14 oz/acre, and applied at Feekes 7. Palisade® EC at 14 oz/acre reduced plant height by 1 to 2 inches when compared to the untreated check. Yield at 14 oz/acre was reduced slightly. The applications caused the males to flower 1 day earlier than the untreated check at both locations.

This experiment shows that topical treatments of Palisade® EC can be used to decrease female parent plant height compared to male parent plant height. Having a height differential of at least 3 inches between female and male parents results in improved pollen dispersal from the male parent and an increase in pollination success.

In addition, applications of Palisade® EC at both rates of 10 oz ai/acre and 14 oz ai/acre delayed male flowering by 1 day. This result demonstrates that Palisade® EC has the potential to delay male flowering enough to decrease contamination of self-pollination of males and resultant inbred male seed in the wheat hybrid seed production system.

Other plant growth regulators with trinexapac-ethyl as the active ingredient are known in the art (e.g. Moddus®, T-Nex®, PrimoMAXX). It is expected that topical treatments of other plant growth regulators with trinexapac-ethyl as the active ingredient at optimized concentrations can also be used as described herein.

### Example 2.2: The Use of MCPA to Limit Tillering Effects

MCPA (2-methyl-4-chlorophenoxyacetic acid) is a post emergence application in wheat that is applied prior to the tillering phase, Feekes stages 3-5. Tillers are new shoots that are sent up from the root of the plant. Each tiller can grow its own stalk and seed head, so the number of tillers will determine the potential yield of the plant. Tillering can occur either before or after the winter dormancy stage in winter wheat, and a plant can have as many as six tillers. MCPA limits the tillering effect, thereby reducing late emerging spikes in the wheat canopy. This results in a shortened male flowering window in wheat.

### Example 2.3: The Use of a Chemical Desiccant and Altered Seeding Rate to Delay Male Flowering

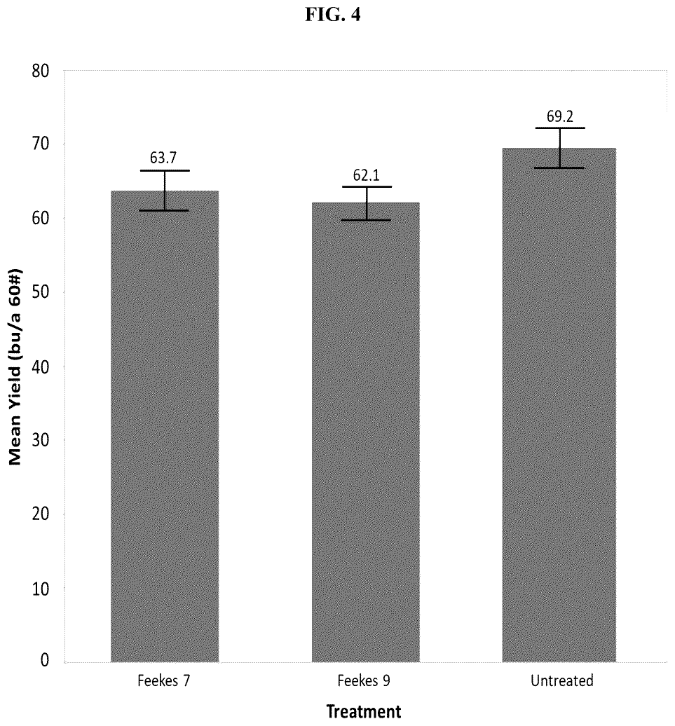

A series of production studies were conducted to understand how to delay male flowering in wheat seed production. Several winter wheat genotypes were planted in a split plot design and sprayed with a commercially available sodium chlorate desiccant at the highest labeled rate at Feekes stages 7 and 9. In most crops, desiccants are typically used to artificially accelerate the drying down of plant tissues. Here, the strategy was to slow growth rates in the male wheat plants to delay heading and subsequent flowering. Initial results showed that applying sodium chlorate at a pre-heading vegetative stage resulted in 1 to 2 day delay in male flowering compared to the non-treated. The desiccant caused a slight 0 to 2 inch (0 to 5 cm) reduction in plant height. Additionally, inbred male yield was reduced when the desiccant was sprayed at both stages, with the greatest reduction shown at Feekes stage 9 (FIG. 4).

Several field studies have been planted to evaluate the proper timing and rate of sodium chlorate applications on male genotypes. One study will evaluate rate and timing effects on male flowering. Rates will be 3 pts ai/acre and applied at Feekes stage 6 and 8.

A second field study will evaluate the effect of seeding rate in combination with sodium chlorate applications to determine if further delayed male flowering can be achieved. Results from previous in-house seeding rate studies showed that reducing seeding rate of the male in a seed production system delayed male flowering by as much as 2.5 days. Sodium chlorate will be applied at the early and mid-vegetative stages and plant height, heading date, flowering date, and yield will be measured.

Results of these studies will determine if the desiccant alone or in combination with a reduced male seeding rate has the potential to delay male flowering enough to decrease contamination of inbred male seed in the wheat hybrid seed production system.

### Example 3: Combination of Methods to Improve Wheat Hybrid Seed Production

Combining methods described herein may have increased impact on wheat hybrid seed production and may result in higher yield of hybrid seed or reduced contamination of inbred seed from the male parents. Methods to increase the growth differential between male and female wheat parents to improve cross-pollination success may be used in combination with interplanting the male and female parents in a seed production field. Methods to increase the growth differential between male and female wheat parents to improve cross-pollination success may be combined with methods to delay male flowering. In a wheat hybrid seed production field, male parents comprising Rht mutant alleles may be treated with GA3 according to the methods described herein to increase the height of the male parents. The male parents comprising Rht mutant alleles may be further treated with a plant growth regulator with trinexapac-ethyl as the active ingredient or with a sodium chlorate desiccant according to the methods described herein to delay male flowering. The male parents comprising Rht mutant alleles may be further treated with a phenoxy herbicide with MCPA (2-methyl-4-chlorophenoxyacetic acid) as the active ingredient to shorten the male flowering window.

In a wheat hybrid seed production field, male parent seeds comprising Rht mutant alleles may be planted at reduced seeding rates to delay flowering and resultant seedlings may be treated with GA3 according to the methods described herein to increase the height of the male parents. Reduced seeding rates of male parents may be combined with a plant growth regulator with trinexapac-ethyl as the active ingredient or sodium chlorate applications to further delay male flowering. Reduced seeding rates of male parents may be combined with a phenoxy herbicide with MCPA (2-methyl-4-chlorophenoxyacetic acid) as the active ingredient to shorten the male flowering window.

Improvement of wheat hybrid seed production may comprise at least one, two, three, or more methods described herein.

We claim:

1. A method of increasing wheat hybrid seed production in a field comprises the steps of:
a. planting male and female parent wheat plants in a field;
b. treating the male parent plants with a gibberellin; and
c. quantifying hybrid seed production, wherein hybrid seed production is increased with respect to a control planting.

2. The method of claim 1, wherein the gibberellin is a spray.

3. The method of claim 1, wherein the gibberellin is GA3 and is sprayed at a dose of 0.5-3 oz of active ingredient (ai)/acre of field area planted when the male parent plants are at Feekes stages 6 to 8.

4. The method of claim 1, wherein the male parent plants comprise a wildtype Rht allele or at least one GA sensitive dwarfing Rht allele.

5. The method of claim 1, wherein the female parent plants comprise at least one GA insensitive dwarfing Rht allele.

6. The method of claim 4, wherein the male parent plants comprise the Rht24 GA sensitive dwarfing allele.

7. The method of claim 5, wherein the female parent plants comprise the GA insensitive dwarfing alleles Rht1, Rht2, or a combination of Rht1 and Rht2.

8. The method of claim 7, wherein the female parent plants further comprise the Rht24 GA sensitive dwarfing allele.

9. A method of claim 1, further comprising the step of interplanting the male and female parent wheat plants in the field.

10. The method of claim 9, further comprising reducing the seeding rate of the male parent wheat plants.

11. The method of claim 10, wherein the amount of male parent seed contamination is reduced in the harvested hybrid seed as compared to a control.

12. A method of increasing wheat hybrid seed production in a field comprising the steps of:
a. planting male and female parent wheat plants in a field;
b. treating the male plants with a topical treatment; and
c. quantifying hybrid seed production, wherein hybrid seed production is increased with respect to a control planting.

13. The method of claim 12, wherein the topical treatment is a plant growth regulator with trinexapac-ethyl as the active ingredient, a sodium chlorate desiccant, or a phenoxy herbicide with MCPA (2-methyl-4-chlorophenoxyacetic acid) as the active ingredient.

14. The method of claim 13, wherein the topical treatment results in at least 1 day delay in male flowering or in a shortened male flowering window.

15. The method of claim 12, wherein the topical treatment is a spray.

16. A method of improving wheat hybrid seed production in a field, wherein the method comprises:
a. interplanting the male and female parent wheat plants in a field;
b. planting male and female plants with GA insensitive or sensitive alleles for Rht1 and Rht2, Rht1 and Rht24, Rht2 and Rht24, or Rht1, Rht2, and Rht24;
c. treating the male parent plants with a gibberellin;
d. treating the male parent plants with a plant growth regulator with trinexapac-ethyl as the active ingredient;
e. treating the male parent plants with a sodium chlorate desiccant;
f. treating the male parent plants with a phenoxy herbicide with MCPA (2-methyl-4-chlorophenoxyacetic acid) as the active ingredient;
g. planting male and female parent wheat plants in a field, wherein the seeding rate of the male parent is reduced;
h. or any combinations of (a)-(g), thereof.

17. A method of claim 16, wherein the method results in:
a. the male parent plant height at least 3 inches greater than the female parent plant height;
b. a delay in male flowering by at least 1 day;
c. a shortened male flowering window of at least 1 day;
d. decreased tillering; or
e. combinations thereof.

18. A method of increasing wheat hybrid seed production in a field, wherein the method comprises:
a. planting male and female parent wheat plants in a field, wherein the male parent wheat plants are GA insensitive and the female parent wheat plants are GA insensitive;
b. treating the male parent wheat plants with a gibberellin;
c. further treating the male parent plants with a topical treatment; and
d. allowing the male parent wheat plants to pollinate the female parent wheat plants to produce an increased amount of hybrid seed as compared to a control.

19. The method of claim 18, further comprising harvesting hybrid seed from the female parent wheat plants.

20. The method of claim 19, wherein the amount of male parent seed contamination is reduced in the harvested hybrid seed as compared to a control.

21. The method of claim 18, further comprising reducing the seeding rate of the male parent wheat plants.

22. The method of claim 18, wherein the topical treatment delays male flowering of the male parent wheat plants or shortens the male flowering window of the male parent wheat plants.

23. The method of claim 22, wherein the topical treatment is a plant growth regulator with trinexapac-ethyl as the active ingredient, a sodium chlorate desiccant, or a phenoxy herbicide with MCPA (2-methyl-4-chlorophenoxyacetic acid) as the active ingredient.
